(19) United States
(12) Patent Application Publication
(10) Pub. No.: US 2013/0122513 A1
(43) Pub. Date: May 16, 2013

(54) DETECTION OF MAGNETICALLY LABELED BIOLOGICAL COMPONENTS

(71) Applicant: Annika Petersson, Angelholm (SE)

(72) Inventor: Annika Petersson, Angelholm (SE)

(73) Assignee: HemoCue AB, Angelholm (SE)

(21) Appl. No.: 13/700,525

(22) PCT Filed: May 30, 2011
(86) PCT No.: PCT/SE11/50674

§ 371 Date: Nov. 28, 2012

(30) Foreign Application Priority Data
Jun. 10, 2010 (SE) 1050593-1

(51) Int. Cl. G01N 27/74

(52) U.S. Cl. CPC G01N 27/74
USPC 435/7.1; 435/287.2

(57) ABSTRACT

A sample acquiring device for detection of biological components in a liquid sample is disclosed, comprising a measurement cavity for receiving a liquid sample and a reagent comprising an antibody linked with a magnetic particle and arranged in a dry form inside the measurement cavity. A method is further disclosed, comprising mixing the reagent with the liquid sample, introducing the liquid sample into the measurement cavity, applying a magnetic field to the liquid, wherein the magnetic particles move in the magnetic field, thereby moving the biological components to which the magnetically labeled antibodies are bound to, acquiring at least one digital image of the sample after the magnetic field has been removed, digitally analysing the at least one digital image for identifying biological components and detecting the magnetically labeled biological components in the measurement cavity. A system comprising the sample acquiring device and a measurement apparatus is also disclosed.

### TECHNICAL FIELD

The present invention relates to a sample acquiring device, a method and a system for detection and volumetric enumeration of magnetically labeled biological components in a liquid sample.

### BACKGROUND ART

In a biological sample different components are often present. In the biological sample, such as a cell sample, it is often desirable to analyse the different types of cells present. These different components display their respective molecular structures, such as cell surface markers, by which the components may be distinguished. By using antibodies, each antibody linked with a magnetic particle, arranged to bind to these molecular structures the biological components may be magnetically labeled and subsequently identified after applying a magnetic field for moving the marked components.

A few techniques for detecting and analysing different types of cells are known in the art, but flow cytometry technique is predominantly used.

In flow cytometry, suspended fluorescence labeled cells are passed, one by one, through a flow channel in front of a laser beam and the fluorescence of several different wavelengths can be measured, as well as the forward and orthogonal light scatter. Thus the labeling of several different fluorophores, as well as the size and granularity of the cells may be analysed. Flow cytometry methods are disclosed in e.g. U.S. Pat. Nos. 3,826,364; 4,284,412 and 5,047,321.

In US 2006/0024756 a device, method and algorithm for enumeration of fluorescently and magnetically labeled cells is disclosed. According to the disclosed method all cells are fluorescently labeled, but only the target cells are also magnetically labeled. The labeled cell sample is placed in a chamber or a cuvette between two wedge-shaped magnets to selectively move the magnetically labeled cells to an observation surface of the cuvette. An LED illuminates the cells and a CCD camera captures the images of the fluorescent light emitted by the target cells. Cell labeling can take place in the cuvette or chamber used for analysis, or the sample is transferred to such a cuvette or chamber after sufficient time is allowed to permit cell labeling. The volume of the cuvette is known and is used to determine the absolute concentration of the target cells in the blood sample. However, this requires waiting until all target cells have been magnetically moved to an observation surface before they can be detected and counted.

U.S. Pat. Nos. 4,910,148 discloses a method and device for separating magnetized particles from biological fluids contained in a sample container. Cells, such as cancer cells, can thus be separated from other cells by the addition of monoclonal antibodies, connected to polymer particles containing iron, to the fluid. By the aid of a magnet, placed on the outside of the container, the cells which have bound to the antibody are retained inside the container as the fluid is withdrawn from the container.

Magnetic polymer particles and process for their preparation are disclosed in U.S. Pat. Nos. 4,654,267. The magnetic polymer particles are produced by mixing a solution of iron(II) salts, an aqueous dispersion of filterable polymer particles and a base to increase the pH of the solution. The process is performed in the absence of oxygen and iron(II) compounds are oxidized to iron(III) compounds, which are transported into the polymer particles making them paramagnetic.

WO 2008/010761, incorporated herein by reference, discloses an apparatus and a method for enumeration and typing of particles in a sample. The method comprises the steps of acquiring at least one magnified digital image of the sample, identifying particles that are imaged in focus in the image, and determining the types and numbers of these particles. The measurement apparatus for enumeration of particles or white blood cells in a sample comprises a holder, arranged to receive a sample acquiring device that holds a sample, an imaging system, comprising a magnifying means and at least one digital image acquiring means being arranged to acquire at least one digital image of the sample, and an image analyser, arranged to analyse the digital image for identifying particles and determining the number of particles and arranged to analyse the digital image for identifying particles that are imaged in focus, determining types of these particles, the types being distinguished by physical features and determining the ratio of different types of particles.

WO 2006/096126, incorporated herein by reference, discloses a method and a system for volumetric enumeration of white blood cells. The method comprises acquiring a blood sample into a measurement cavity of a sample acquiring device, wherein the measurement cavity holds a reagent comprising a hemolysing agent and a staining agent to react with the sample such that the white blood cells are stained. The method further comprises irradiating the sample, acquiring one digital image of a magnification of the irradiated sample in the measurement cavity, wherein the white blood cells in the sample are distinguished by the selective staining, and then digitally analysing the digital image for identifying the white blood cells and determining the number of white blood cells in the sample. The digital image is acquired with a depth of field at least corresponding to the thickness of the measurement cavity and a sufficient focus is obtained of the entire sample thickness such that the entire thickness of the measurement cavity may be simultaneously analysed in the one digital image of the sample. By choosing not to focus very sharply on a specific part of the sample, a sufficient focus is obtained of the entire sample thickness allowing identifying the number of white blood cells in the sample.

### SUMMARY OF THE INVENTION

It is an object of the invention to provide a simple analysis for detecting magnetically labeled biological components of a liquid sample.

According to one aspect of the invention it is an object to provide a simple analysis for volumetric enumeration of magnetically labeled biological components of a liquid sample.

It is a further object of the invention to provide a quick analysis without the need for complicated apparatuses or extensive sample preparations.

These objects are partly or wholly achieved by a sample acquiring device, a method and a system according to the independent claims. Preferred embodiments are evident from the dependent claims.

According to one aspect, the present invention thus relates to a sample acquiring device for detection of biological components in a liquid sample. The sample acquiring device comprises a measurement cavity for receiving a liquid sample, wherein the measurement cavity has a predetermined fixed thickness defined between the inner walls of the measurement cavity. The sample acquiring device also comprises a reagent, which is arranged in a dry form inside the measurement cavity, said reagent comprising an antibody linked with a magnetic particle.

The liquid sample may be, e.g., a bodily fluid, such as undiluted whole blood, urine or spinal fluid; or a cell culture, such as a mammalian cell culture or a bacterial culture. The liquid sample may be an undiluted biological fluid which has not undergone any pre-treatment. Pre-treatment of a biological sample, such as dilution, centrifugation and lysing leads to a lower accuracy when relating enumerated target cells to the analysed volume. The more pre-treatment steps performed, the lower the accuracy of the enumeration becomes. By not employing any type of pre-treatment before entering the sample into the ready-to-use sample acquiring device the method is simplified further. It is thus possible to detect the presence or amount of, e.g., a specific cell type in a blood sample.

The biological components of the liquid sample may be, e.g., eukaryotic cells, such as mammalian cells (e.g. leucocytes and platelets); bacteria; viruses; and macro molecules, such as DNA.

The reagent in the sample acquiring device may further comprise a hemolysing agent for lysing red blood cells in a blood sample, and/or a staining agent for selectively staining specific cells in a liquid sample.

The hemolysing agent may be a quaternary ammonium salt, a saponin, a bile acid, such as deoxycholic acid, a digitoxin, a snake venom, a glucopyranoside or a non-ionic detergent of type Triton®. However, it should be appreciated that the hemolysing agent is not limited to this group, but many other substances may be contemplated.

The staining agent may be any one in the group of Hematoxylin, Methylene blue, Methylene green, Methylene azure, cresyl violet acetate, eosin Y or eosin B, Toluidine blue, Gentian violet, Sudan analogues, Gallocyanine, and Fuchsin analogues, or any combination thereof. However, it should be appreciated that the staining agent is not limited to this group, but many other substances may be contemplated.

The sample acquiring device provides a possibility to directly obtain a sample of whole blood into the measurement cavity and provide it for analysis. There is no need for sample preparation; a blood sample may be sucked into the measurement cavity directly from a pricked finger of a patient. Providing the sample acquiring device with a reagent enables a reaction within the sample acquiring device which makes the sample ready for analysis. The reaction is initiated when the blood sample comes into contact with the reagent. Thus, there is no need for manually preparing the sample, which makes the analysis especially suitable to be performed directly in an examination room while the patient is waiting.

Since the reagent is provided in a dried form, the sample acquiring device may be transported and stored for a long time without affecting the usability of the sample acquiring device. Thus, the sample acquiring device with the reagent may be manufactured and prepared long before making the analysis of a blood sample.

The sample acquiring device of the present invention may thus easily and reproducibly be used by even an untrained person, and not necessarily in a regular standardized laboratory environment, as the sample acquiring device may form a ready-to-use kit where the sample inlet of the sample acquiring device only need to be moved into contact with the sample in order to provide sample in a form ready to be analysed.

The measurement cavity may have a sufficient thickness to allow a quite large volume of the liquid sample to be analysed and therefore allow a good statistic for determining the volumetric count of magnetically labeled biological components. The count of magnetically labeled biological components may thus be obtained by summing the number of individually detected magnetically labeled biological components that have been moved towards an applied magnetic field in a defined volume.

The sample acquiring device may comprise a body member having two planar surfaces to define said measurement cavity. The planar surfaces may be arranged at a predetermined distance from one another to determine a sample thickness for an optical measurement. This implies that the sample acquiring device provides a well-defined thickness to the optical measurement, which may be used for accurately determining the count of magnetically labeled biological components per volumetric unit of the liquid sample. A volume of an analysed liquid sample will be well-defined by the thickness of the measurement cavity and an area of the sample being imaged. Thus, the well-defined volume could be used for associating the number of magnetically labeled biological components to the volume of the sample such that the volumetric count of magnetically labeled biological components is determined.

The measurement cavity preferably has a uniform thickness of 50-500 micrometers. A thickness of at least 50 micrometers implies that the measurement cavity does not force a liquid sample, such as a cell sample, to be smeared into a monolayer allowing a larger volume of liquid sample to be analysed over a small cross-sectional area. Thus, a sufficiently large volume of the liquid sample in order to give reliable values of the count of magnetically labeled biological components may be analysed using a relatively small image of the cell sample. The thickness is more preferably at least 100 micrometers, which allows an even smaller cross-sectional area to be analysed or a larger sample volume to be analysed. Further, the thickness of at least 50 micrometers and more preferably 100 micrometers also simplifies manufacture of the measurement cavity having a well-defined thickness between the two planar surfaces.

For most samples, e.g. a blood sample, arranged in a cavity having a thickness of no more than 500 micrometers, the count of magnetically labeled biological components, such as cells of a blood sample, is so low that there will be only minor deviations due to components being arranged overlapping each other. However, the effect of such deviations will be related to the count of magnetically labeled biological components and may thus, at least to some extent, be handled by means of statistically correcting results. This statistical correction may be based on calibrations of the measurement apparatus. The deviations will be even less for a measurement cavity having a thickness of no more than 200 micrometers, whereby a simpler calibration may be used. This thickness may not even require any calibration for overlapping biological components. The thickness of the measurement cavity is sufficiently small to enable the measurement apparatus to obtain a digital image such that the entire depth of the measurement cavity may be analysed simultaneously.

The sample acquiring device may be provided with a reagent that has been applied to the surface by insertion into the measurement cavity. The reagent is advantageously solved in a volatile liquid which has evaporated to leave the reagent in a dried form. This implies that the liquid may in an effective manner be evaporated from the narrow space of the measurement cavity during manufacture and preparation of the sample acquiring device.

The reagent may preferably be solved in an organic solvent and more preferably be solved in methanol. Such solvents are volatile and may appropriately be used for drying the reagent onto a surface of the measurement cavity.

The reagent, including all its components, of the present invention is preferably dissolvable and/or suspendable in the liquid sample to be analysed, and is preferably intended to stay in solution/suspension throughout the analysis. Using a dissolvable/suspendable reagent, preferably an easily dissolvable/suspendable reagent, facilitates mixing of the reagent with the liquid sample and accelerates any reactions between the reagent and the liquid sample including the biological component to be measured.

The reagent of the present invention comprises an antibody linked with a magnetic particle. The antibody linked with a magnetic particle is preferably arranged to bind to a specific molecular structure of a biological component. Examples of such molecules include antigens as, but are not limited to, ligands, receptors, antibodies and antibody fragments. Examples of antibody fragments regions are e.g. fragment antigen binding region (Fab), fragment crystallizable region (Fc) and single chain fragment variable.

The molecular structure may be any specific molecular structure of a biological component, e.g., a cell surface marker, such as CD4 or CD8, or an intra cellular structure, such as DNA. A cell surface marker is herein defined as any molecular characteristic of the plasma membrane of a cell which is accessible from the outside of the cell, such as an antigen. This implies that any types of cells may be detected for any purpose, such as detecting and enumerating CD4 positive cells for the sake of monitoring an HIV infection.

The amount of antibodies linked with magnetic particles is preferably selected so that there is a sufficient amount to bind to the biological components. In order to ensure that essentially all targeted biological molecules are adequately labeled by the antibody within reasonable time the antibodies linked with magnetic particles need to be present in excess. There will however still be unbound antibodies linked with magnetic particles in the mixed sample and it is desired that this unbound concentration is kept sufficiently low to keep down the background when the sample is analysed. Thus, the antibodies linked with magnetic particles should not be present in too large excess. The ratio of bound to unbound antibodies is dependent on the affinity between the antibody and the biological component, and the time allocated for mixing the antibodies with the biological component.

The sample acquiring device may further comprise a sample inlet communicating the measurement cavity with the exterior of the sample acquiring device, said inlet being arranged to acquire a liquid sample. The sample inlet may be arranged to draw up a liquid sample by capillary force and the measurement cavity may further draw liquid from the inlet into the cavity. As a result, the liquid sample may easily be acquired into the measurement cavity by simply moving the sample inlet into contact with the liquid. Then, the capillary forces of the sample inlet and the measurement cavity will draw up a well-defined amount of liquid into the measurement cavity. Alternatively, the liquid sample may be sucked, aspirated or drawn into the measurement cavity by means of applying an external pumping force to the sample acquiring device. According to another alternative, the liquid sample may be acquired into a pipette and then be introduced into the measurement cavity by means of the pipette.

The sample acquiring device may be disposable, i.e. it is arranged to be used only once. The sample acquiring device provides a kit for performing a count of magnetically labeled biological components, since the sample acquiring device is able to receive a liquid sample and holds all reagents needed in order to present the sample to counting. This is particularly enabled since the sample acquiring device is adapted for use only once and may be formed without consideration of possibilities to clean the sample acquiring device and re-apply a reagent. Also, the sample acquiring device may be moulded in a plastic material and thereby be manufactured at a low cost. Thus, it may still be cost-effective to use a disposable sample acquiring device.

According to another aspect, the present invention relates to a method for detection of magnetically labeled biological components in a liquid sample. The method comprises mixing a reagent comprising an antibody linked with a magnetic particle with a liquid sample such that the antibody binds to a specific molecular structure of a biological component in the liquid sample; introducing the liquid sample into a measurement cavity of a sample acquiring device, said measurement cavity having a predetermined fixed thickness; optionally acquiring at least one digital image of a magnification of the irradiated sample in the measurement cavity; applying a magnetic field to the liquid sample in the measurement cavity, such that the magnetic particle is moved towards the magnetic field and thereby moving the biological component, to which the magnetically labeled antibody is bound to; acquiring at least one digital image of a magnification of the irradiated sample in the measurement cavity after the magnetic field has been removed from said measurement cavity; digitally analysing the at least one digital image for identifying biological components that are imaged in focus and determining positions, types and number of these biological components, the positions being determined by the physical features of the digital image and the types being distinguished by physical features of the components; and detecting the magnetically labeled biological components in the measurement cavity, said detecting comprising identifying in the at least one digital image the magnetically labeled biological components positioned at one of the planar surfaces of the measurement cavity.

According to one embodiment of the method for detection of magnetically labeled biological components in a liquid sample, the detection of the magnetically labeled biological components in the measurement cavity comprises identifying the magnetically labeled biological components that have been moved towards the applied magnetic field, wherein the identifying comprises comparing the positions of the identified biological components in the at least first acquired digital image with the positions of the identified biological components in the at least second acquired digital image, wherein the magnetically labeled biological components have changed their positions from the at least first acquired digital image to the at least second acquired digital image.

According to one embodiment of the method for detection of magnetically labeled biological components in a liquid sample, the applied magnetic field is moved along the planar measurement cavity, i.e. perpendicular to the irradiation direction of the measurement cavity. The movement of the magnetic field over the imaged area of the measurement cavity may be with constant, increasing or decreasing speed. When the applied magnetic field is moving perpendicular to the irradiation direction of the measurement cavity, the magnetically labeled biological components are moved out of the subsequently at least second acquired image making it easy to detect the biological components that are magnetically labeled when comparing the at least first acquired image to the at least second acquired image.

According to one embodiment of the method for detection of magnetically labeled biological components in a liquid sample, the digital analysis of the at least one digital image comprises determining positions and number of the biological components that are imaged in sufficient focus in the entire sample thickness wherein the at least one digital image is acquired with a depth of field at least corresponding to the thickness of the measurement cavity.

As used in this context, “depth of field” implies a length in a direction along the optical axis that is imaged in a sufficient focus to allow image analysis to identify cells positioned within this length. This “depth of field” may be larger than a conventional depth of field defined by the optical settings.

According to one embodiment of the method for detection of magnetically labeled biological components in a liquid sample, the sample acquiring device comprises a reagent, which is arranged in a dry form inside the measurement cavity, wherein the reagent comprises an antibody linked with a magnetic particle. Then, mixing is achieved by introducing the liquid sample into the measurement cavity to make contact with the reagent. This implies that there is no need for sample preparation. A reaction may be initiated when the blood sample comes into contact with the reagent. Thus, there is no need for manually preparing the sample, which makes the analysis especially suitable to be performed directly in an examination room while the patient is waiting.

However, according to an alternative embodiment the mixing of the reagent with the liquid sample may be performed prior to the liquid sample is introduced into the measurement cavity. According to another alternative, mixing may be performed in at least two steps, wherein a first step is performed before the sample is introduced into the measurement cavity and the second step is performed in the measurement cavity. This implies that sample preparation is at least partly made outside the sample acquiring device. However, the advantage of using a sample acquiring device having a measurement cavity with a fixed thickness is still maintained. Thus, the method provides a possibility to determine the count of biological components per volumetric unit of the liquid sample.

The liquid sample is preferably introduced into the measurement cavity of the sample acquiring device through a capillary sample inlet by means of capillary force.

The at least one digital image for determination of positions, types and number of the biological components may be acquired by a measurement apparatus according to the one disclosed in WO 2008/010761, i.e. acquiring the at least one digital image by an imaging system using a magnification power of about 10× with a depth of field in the range of about 8-10 micrometers.

The at least one digital image for determination of positions and number of the biological components may be acquired by a measurement apparatus according to the one disclosed in WO 2006/096126, i.e. acquiring the at least one digital image by an imaging system using a magnification power of about 3-4× with a depth of field in the range of about 140-170 micrometers.

The measurement apparatuses of WO 2008/010761 and WO 2006/096126 may be modified for use in the method of the invention by adding means for generating a magnetic field on either or both sides of the measurement cavity. The magnetic field may be generated by positioning a permanent magnet and/or an electromagnet to either side or both sides of the sample acquiring device comprising the measurement cavity. The applied magnetic field may then influence the magnetically labeled biological components for a suitable period of time, preferably less than 10 minutes. The magnetically labeled biological components in the liquid sample are then moved towards the magnetic field of the magnet. The permanent magnet may also be supplied with means for changing its position, from influencing the magnetically labeled biological components in the measurement cavity to a position where the magnetic field of the magnet does not influence the magnetically labeled biological components in the measurement cavity. When the magnetic field is generated by an electromagnet, the magnetic field may be switched off when it is not needed anymore. The permanent magnet or electromagnet positioned on one or both sides of the measurement cavity may also be provided with means for moving along the measurement cavity. The permanent magnet or electromagnet may be moved by constant, increasing or decreasing speed, thus moving the applied magnetic field also.

The analysing may further comprise electronically magnifying the at least one acquired digital image. While the sample is being magnified for acquiring a magnified digital image of the sample, the acquired digital image itself may be electronically magnified for simplifying distinguishing between objects that are imaged very closely to each other in the acquired digital image.

In yet another embodiment, the present invention relates to a system for volumetric enumeration of magnetically labeled biological components in a liquid sample, said system comprising a sample acquiring device as defined above, and a measurement apparatus comprising a sample acquiring device holder arranged to receive the sample acquiring device which contains a liquid sample in the measurement cavity and means for applying a magnetic field to the measurement cavity, a light source arranged to irradiate the liquid sample with electromagnetic radiation of a predetermined wavelength, an imaging system, comprising a digital image acquiring means for acquiring at least one digital image of the irradiated sample in the measurement cavity, wherein magnetically labeled biological components are distinguished in the at least one digital image by selective electromagnetic wavelength imaging, and an image analyser arranged to analyse the acquired at least one digital image for identifying magnetically labeled biological components and determining the number and positions of magnetically labeled biological components in the liquid sample.

The imaging system may be arranged to acquire a plurality of digital images of the sample using different optical settings, wherein the image analyser is arranged to analyse each acquired digital image for identifying biological components or stained white blood cells and determining the number and positions of the biological components or white blood cells in the sample, wherein the image analyser is arranged to analyse each acquired digital image for identifying biological components or white blood cells that are imaged in focus and determining positions, types and number of these biological components or white blood cells, the positions being determined by the physical features of the digital image and the types being distinguished by geometric features of the biological components or stained white blood cells, whereby the ratio and positions of different types of biological components or white blood cells in the sample is determined.

By acquiring a plurality of digital images at different levels in the direction of depth of field in the sample, it is possible to analyse a relatively large sample volume even when using a high magnification. A high magnification makes it, due to the resulting small depth of field, difficult to view the complete volume in one image. Since the magnification level affects the depth of field, the step of acquiring a plurality of digital images allows the use of a greater magnification, which in turn makes it possible to, in each image, differentiate between different kinds of biological components or white blood cells depending, amongst others, upon the shape, number or size of the nuclei.

The imaging system may be arranged to acquire a single digital image of the sample, acquired with a depth of field at least corresponding to the thickness of the measurement cavity. A sufficient focus is obtained of the entire sample thickness, which then is simultaneously analysed in the single digital image of the sample. Sharp focus is not specified on a specific part of the sample and a sufficient focus is obtained of the entire sample thickness. The image analyser is arranged to analyse the acquired digital image for identifying biological components or stained white blood cells and determining the number and positions of the biological components or white blood cells in the sample, wherein the image analyser is arranged to analyse the acquired digital image for identifying biological components or white blood cells that are imaged sufficiently in focus and determining positions and number of these biological components or white blood cells, the positions being determined by the physical features of the digital image whereby the ratio and positions of biological components or white blood cells in the sample is determined.

By acquiring a single digital image of the sample using a depth of field at least corresponding to the thickness of the measurement cavity the entire sample volume will be analysed, although without the possibility to differentiate between different kinds of biological components or white blood cells but with the possibility to single out the ones that are no longer present in a second acquired image.

The measurement apparatus may utilize the properties of the sample acquiring device as described above for making an analysis of a liquid sample that has been directly acquired into the measurement cavity. The measurement apparatus may image a determined volume of the sample for making a volumetric enumeration of biological components in the sample.

### BRIEF DESCRIPTION OF THE DRAWINGS

The invention will now be described in further detail by way of example under reference to the accompanying drawings.

FIG. 1 is a schematic view of a sample acquiring device according to an embodiment of the invention.

FIG. 2 is a flow chart of a method according to an embodiment of the invention.

FIG. 3 is a flow chart of a method according to another embodiment of the invention.

FIG. 4 is a schematic view of a measurement system according to an embodiment of the invention.

FIG. 5 a. is a schematic view of a measurement system according to another embodiment of the invention, before an analysis of the content in the measurement cavity is started,
b. is a schematic view of the measurement cavity after a magnetic field has been applied, and
c. is a schematic view of the measurement cavity after a moving magnetic field has been applied.

### DETAILED DESCRIPTION OF A PREFERRED EMBODIMENT

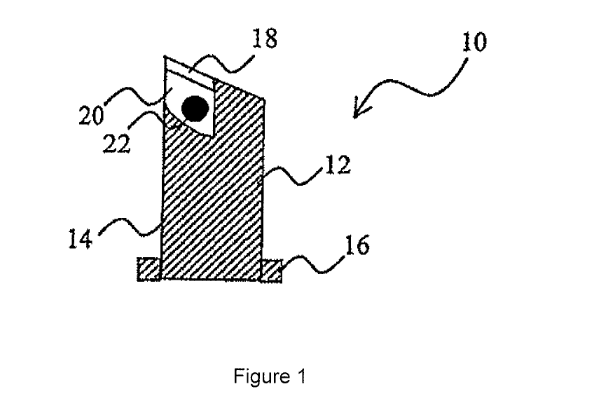

Referring now to FIG. 1, a sample acquiring device 10 according to an embodiment of the invention will be described. The sample acquiring device 10 is disposable and is to be thrown away after having been used for analysis. This implies that the sample acquiring device 10 does not require complicated handling. The sample acquiring device 10 is formed in a plastic material and is manufactured by injection-moulding. This makes manufacture of the sample acquiring device 10 simple and cheap, whereby the cost of the sample acquiring device 10 is kept down.

The sample acquiring device 10 comprises a body member 12, which has a base 14, which may be touched by an operator without causing any interference in analysis results. The base 14 may also have projections 16 that fit a holder in an analysis apparatus. The projections 16 are arranged such that the sample acquiring device 10 will be correctly positioned in the analysis apparatus.

The sample acquiring device 10 further comprises a sample inlet 18. The sample inlet 18 is defined between opposite walls within the sample acquiring device 10, the walls being arranged so close to each other that a capillary force is created in the sample inlet 18. The sample inlet 18 communicates with the exterior of the sample acquiring device 10 for allowing liquid or blood to be drawn into the sample acquiring device 10. The sample acquiring device 10 further comprises a chamber for counting magnetically labeled biological components, such as cells, in the form of a measurement cavity 20 arranged between opposite walls inside the sample acquiring device 10. The measurement cavity 20 is arranged in communication with the sample inlet 18. The walls defining the measurement cavity 20 are arranged closer together than the walls of the sample inlet 18, such that a capillary force may draw blood from the sample inlet 18 into the measurement cavity 20.

The measurement cavity 20 is in communication with the sample inlet 18. The walls of the measurement cavity 20 are arranged at a distance from each other of 50-500 micrometers. The measurement cavity 20 is more preferably at least 100 micrometers thick. Further, the measurement cavity 20 is more preferably no more than 250 micrometers thick. The distance is generally uniform over the entire measurement cavity 20. The generally uniform thickness of the measurement cavity 20 needs to be very precise, i.e. only very small variations in the thickness between the walls of the cavity are allowed between different sample acquiring devices 10. The thickness is chosen to allow a relatively large sample volume to be analysed in a small area of the measurement cavity 20 so that a sufficient number of biological components or cells are available for counting. The entire thickness of the measurement cavity 20 may be chosen to allow it to be imaged within a depth of field of an imaging system. Then, an image may be analysed and the number of biological components or white blood cells present in the image may be counted in order to determine the volumetric biological component count or white blood cell count.

The measurement cavity 20 is also adapted for determining a ratio of different types of biological components in a sample or white blood cells in a blood sample. The entire thickness of the measurement cavity 20 is to be imaged within a depth of field of an imaging system. Then, an image may be analysed and the number of biological components or white blood cells of each type present in the image may be counted in order to determine the ratio of different types of biological components or white blood cells.

The measurement cavity 20 is adapted to be imaged in its entirety within a depth of field of an imaging system. Thus, all biological components or white blood cells within the sample are imaged in focus and the analysis of the sample is not hampered by noise in the image from parts of the sample imaged out of focus. A magnification may be needed in order to allow counting the total number of biological components or white blood cells and also determining the type of biological components or white blood cells.

The sample acquiring device 10 is adapted to measure magnetically labeled cell counts above 0.05×10⁹ cells/liter liquid or blood. At lower cell counts, the sample volume will be too small to allow statistically significant amounts of cells to be counted. Further, when the magnetically labeled cell count exceeds 30×10⁹cells/liter liquid or blood, the effect of cells being arranged overlapping each other will start to be significant in the measured cell count. At this count of magnetically labeled cells, the labeled cells will cover approximately 8% of the cross-section of the sample being irradiated when the thickness of the measurement cavity is less than 200 micrometers. Thus, in order to obtain correct counts of magnetically labeled cells, this effect will need to be accounted for. Therefore, a statistical correction of values of the labeled cell count above 12×10⁹ labeled cells/liter liquid or blood may be used. This statistical correction will be increasing for increasing counts of magnetically labeled cells, since the effect of overlapping labeled cells will be larger for larger cell counts. The statistical correction may be determined by means of calibration of a measurement apparatus. As an alternative, the statistical correction may be determined at a general level for setting up measurement apparatuses to be used in connection to the sample acquiring device 10. It is contemplated that the sample acquiring device 10 could be used to analyse counts of magnetically labeled cells as large as 50×10⁹ labeled cells/liter liquid or blood.

According to an alternative embodiment, the detection of magnetically labeled biological components is used for determining whether a specific biological component is present in the sample or not. In this embodiment, there is no need to perform a volumetric count and, thus, the presence of a biological component may be detected even for very small amounts of the component in the sample.

A surface of a wall of the measurement cavity 20 is at least partly coated with a reagent 22. The reagent 22 may be freeze-dried, heat-dried or vacuum-dried and applied to the surface of the measurement cavity 20. When a sample is acquired into the measurement cavity 20, the sample will make contact with the dried reagent 22 and initiate a binding reaction between the reagent 22 and the sample components.

The reagent 22 is applied by inserting the reagent 22 into the measurement cavity 20 using a pipette or dispenser. The reagent 22 is solved in methanol when inserted into the measurement cavity 20. The solvent with the reagent 22 fills the measurement cavity 20. Then, drying is performed such that the solvent is evaporated and the reagent 22 is attached to the surfaces of the measurement cavity 20.

Since the reagent is to be dried onto a surface of a narrow space, the liquid will have a very small surface in contact with ambient atmosphere, whereby evaporation of the liquid is rendered more difficult. Thus, it is advantageous to use a volatile liquid, such as methanol, which enables the liquid to be evaporated in an effective manner from the narrow space of the measurement cavity.

According to an alternative manufacturing method, the sample acquiring device 10 is formed by attaching two pieces to each other, whereby one piece forms the bottom wall of the measurement cavity 20 and the other piece forms the top wall of the measurement cavity 20. This allows a reagent 22 to be dried onto an open surface before the two pieces are attached to each other. Thus, the reagent 22 may be solved in water, since the solvent need not be volatile.

The reagent 22 may comprise one or more antibodies linked with magnetic particles. The antibodies are adapted to bind to a specific molecular structure characteristic of the targeted biological component, such as a cell. The structure may be a cell surface marker, such as CD4 or CD8. When a liquid sample makes contact with the reagent 22, the antibodies will act to bind to the specific molecular structure of the targeted cells, thus accumulating at the cells. The reagent 22 should preferably contain sufficient amounts of antibody to distinctly label portions of the targeted cells essentially covering the entire cells. This implies that essentially the entire labeled cells are magnetic and may thus be easily detected in the sample. Further, there will often be a surplus of antibodies with magnetic particles, which will be intermixed in the liquid but will not pose any problem since the unbound antibodies are too small to be detected.

The reagent 22 may also comprise other constituents, which may be active, i.e. taking part in the chemical binding to, e.g., cells of a blood sample, or non-active, i.e. not taking part in the binding. The active constituents may e.g. be arranged to facilitate the binding of the antibodies to their respective target molecular structures. The non-active constituents may e.g. be arranged to improve attachment of the reagent 22 to the surface of a wall of the measurement cavity 20.

Within a few minutes, the blood sample will have reacted with the reagent 22, such that the antibodies with magnetic particles have bound to the targeted cells.

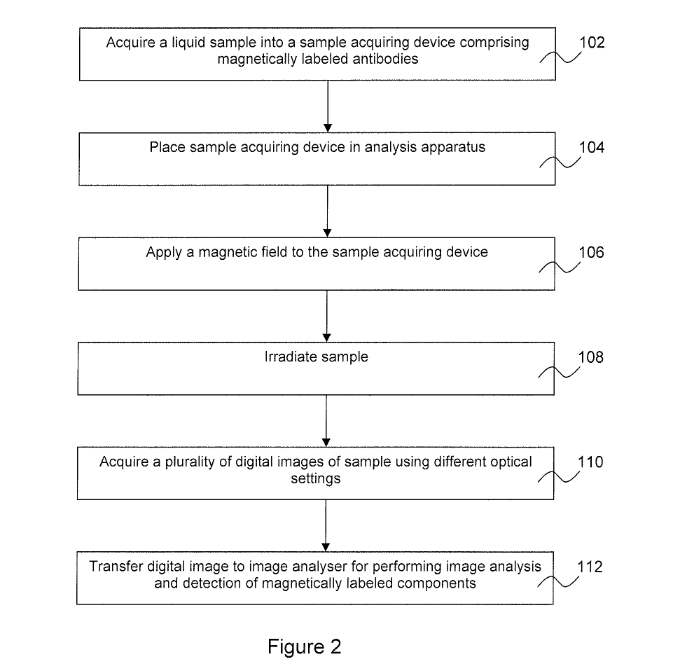

Referring to now FIG. 2, a method for detection of magnetically labeled biological components in a sample will be described. The method will be specifically described with reference to a method for detection and volumetric enumeration of magnetically labeled CD4 positive T lymphocytes. However, it will be appreciated by those skilled in the art that the method may be modified for detection and volumetric enumeration of other biological components. A suitable reagent needs to be used for magnetically labelling the biological components of interest, and irradiation and detection may need to be adapted, as will be appreciated by those skilled in the art.

The method for detection and volumetric enumeration of magnetically labeled CD4 positive T lymphocytes comprises acquiring a blood sample in a sample acquiring device 10, step 102, having a fixed thickness of less than 200 μm. An undiluted sample of human whole blood is acquired into the sample acquiring device 10. The sample may be acquired from capillary blood or venous blood. A sample of capillary blood may be drawn into the measurement cavity 20 directly from a pricked finger of a patient. The blood sample makes contact with the reagent 22 in the sample acquiring device 10, initiating a binding reaction. The reagent comprises magnetically labeled anti-CD4 antibody. Within a few minutes, the blood sample will have reacted with the reagent 22, such that the magnetically labeled antibodies have bound to the CD4 markers of the T helper lymphocytes, and the sample is now ready to be analysed. The sample acquiring device 10 is placed in an analysis apparatus, step 104. An analysis may be initiated by pushing a button of the analysis apparatus. Alternatively, the analysis is automatically initiated by the apparatus detecting the presence of the sample acquiring device 10.

A magnetic field is applied to the reacted blood sample in the sample acquiring device 10 in order to move the magnetically labeled cells towards the magnetic field, step 106. The sample is irradiated, step 108, and a CCD camera is used to acquire a plurality of images of the sample, using different optical settings, step 110.

The acquired digital images are transferred to an image analyser, performing an electronic magnification image analysis, step 112, in order to count the number of dark dots, positioned at one of the planar surfaces of the measurement cavity, in the respective digital image. The image analyser is thus capable of determining the concentrations of CD4 positive T helper cells in the blood sample.

Alternatively, the liquid sample, whole blood in this case, may be reacted, or partly reacted, with the reagent 22 (magnetically labeled antibodies) outside of the sample acquiring device 10, after which the reacted, or partly reacted, sample may be acquired in the sample acquiring device 10.

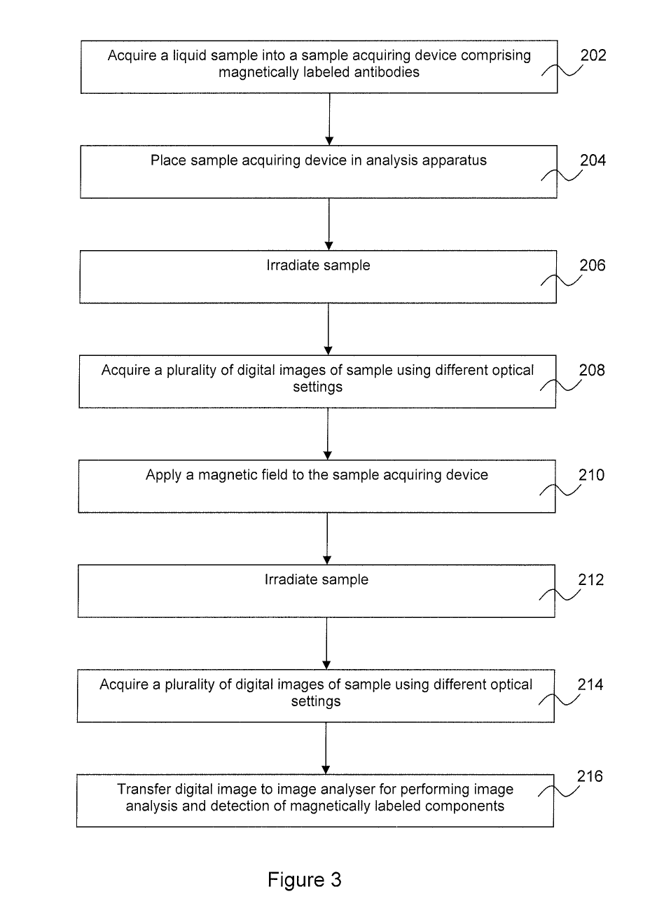

Referring now to FIG. 3, an alternative method for detection of magnetically labeled biological components in a sample will be described. The method will be specifically described with reference to a method for detection and volumetric enumeration of magnetically labeled CD4 positive T lymphocytes.

The method for detection and volumetric enumeration of magnetically labeled CD4 positive T lymphocytes comprises acquiring a blood sample in a sample acquiring device 10, step 202, having a fixed thickness of less than 200 μm. An undiluted sample of human whole blood is acquired into the sample acquiring device 10. The sample may be acquired from capillary blood or venous blood. A sample of capillary blood may be drawn into the measurement cavity 20 directly from a pricked finger of a patient. The blood sample makes contact with the reagent 22 in the sample acquiring device 10, initiating a binding reaction. The reagent comprises magnetically labeled anti-CD4 antibody. Within a few minutes, the blood sample will have reacted with the reagent 22, such that the magnetically labeled antibodies have bound to the CD4 markers of the T helper lymphocytes, and the sample is now ready to be analysed. The sample acquiring device 10 is placed in an analysis apparatus, step 204. An analysis may be initiated by pushing a button of the analysis apparatus. Alternatively, the analysis is automatically initiated by the apparatus detecting the presence of the sample acquiring device 10.

The sample is irradiated, step 206, and a CCD camera is used to acquire a plurality of images of the sample, using different optical settings, step 208. A magnetic field is then applied to the reacted blood sample in the sample acquiring device 10 in order to move the magnetically labeled cells towards the magnetic field, step 210. The sample is irradiated a second time after the magnetic field has been removed, step 212, and a CCD camera is used to acquire a second plurality of images of the sample, using different optical settings, step 214.

The acquired digital images are transferred to an image analyser, performing an electronic magnification image analysis, step 216, in order to compare the positions of the identified cells in the first acquired plurality of images with the positions of the identified cells in the second acquired plurality of images. The magnetically labeled cells have changed their positions in the measurement cavity 20 from the first acquired plurality of images compared to the second acquired plurality of images and identification is thus achieved and the image analyser can then determine the concentration of CD4 positive T helper cells in the blood sample.

Alternatively, the applied magnetic field is moved along the planar measurement cavity 20, i.e. perpendicular to the irradiation direction of sample acquiring device 10. The movement of the magnetic field can be with constant, increasing or decreasing speed. When the applied magnetic field is moving perpendicular to the irradiation direction of the measurement cavity 20, the magnetically labeled biological components are moved away from of the area wherefrom the digital image of the measurement cavity 20 is acquired. No magnetically labeled cells are therefore detected in the second acquired plurality of images. The detection of the magnetically labeled cells is thus performed by identifying cells that are not present in the second plurality of images compared to the first plurality of images.

Alternatively, the liquid sample, whole blood in this case, may be reacted, or partly reacted, with the reagent 22 (magnetically labeled antibodies) outside of the sample acquiring device 10, after which the reacted, or partly reacted, sample may be acquired in the sample acquiring device 10.

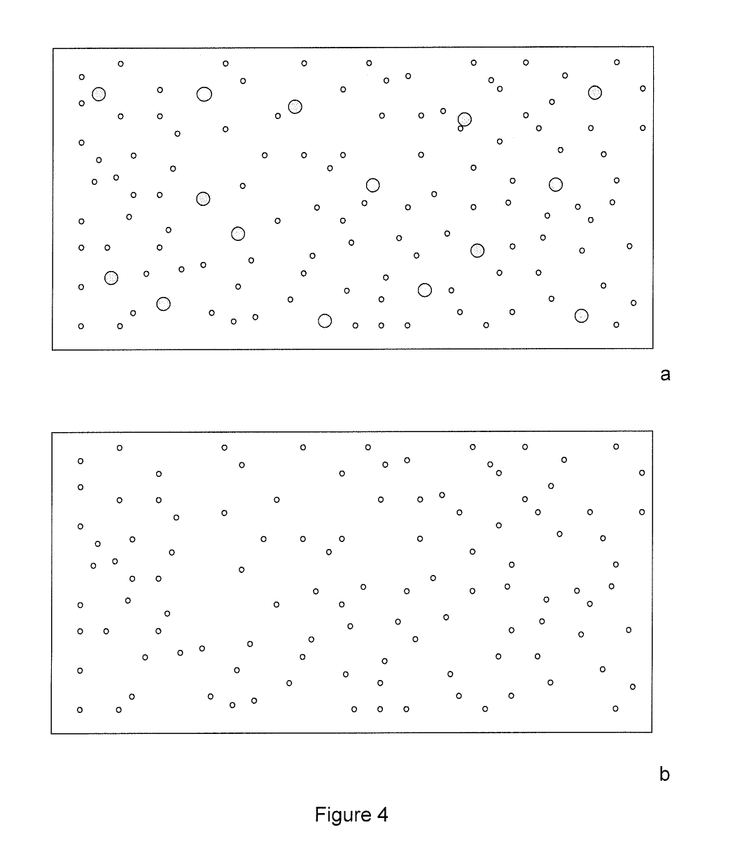

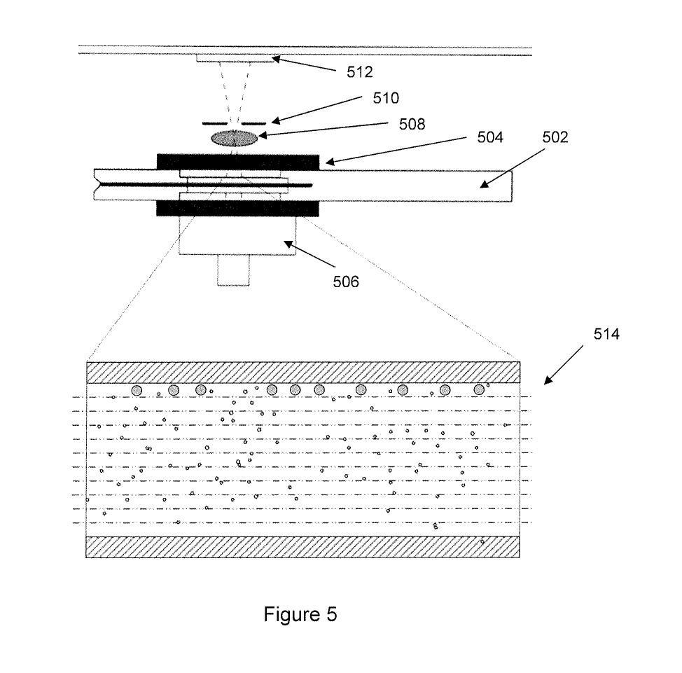

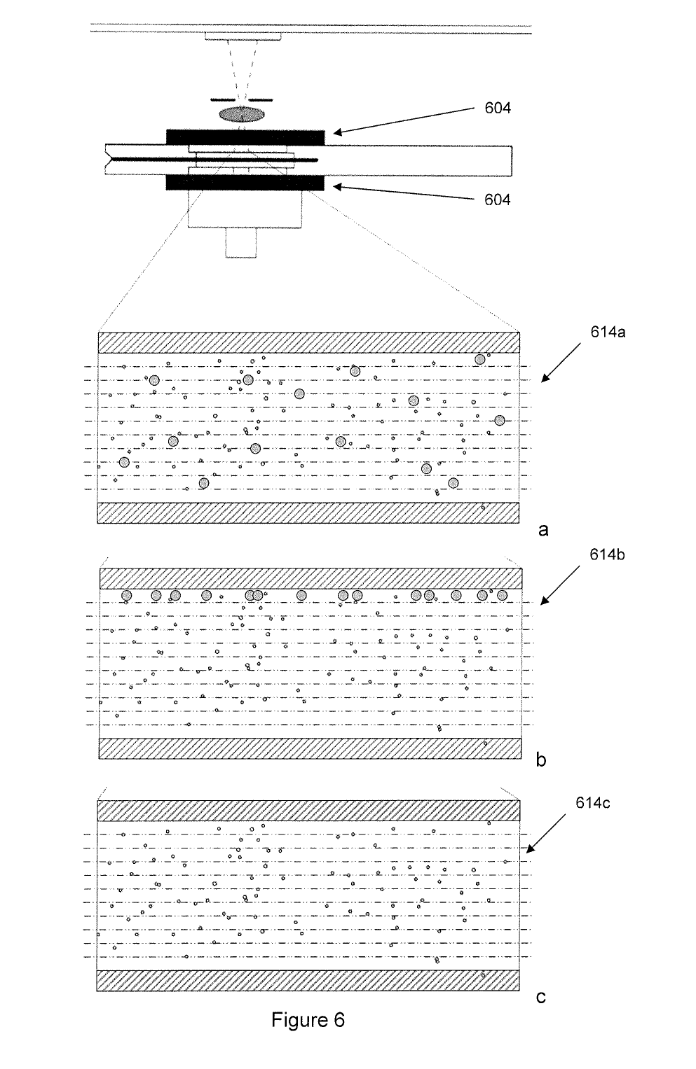

Alternatively, a single digital image of a magnification of the irradiated sample in the sample acquiring device 10 is acquired in step 208. The single digital image is acquired with a depth of field at least corresponding to the thickness of the measurement cavity 20. A sufficient focus is obtained of the entire sample thickness, which then is simultaneously analysed in the single digital image of the sample. Sharp focus is not specified on a specific part of the sample and a sufficient focus is obtained of the entire sample thickness, FIG. 4a, and the magnetically labeled biological components are seen in the magnification of the measurement cavity as gray dots, size enlarged compared to the other biological components for clarification. The magnetic field is applied, step 210, moving along the planar measurement cavity 20, i.e. perpendicular to the irradiation direction of sample acquiring device 10. The sample is irradiated again, step 212, after the magnetic field has been removed, and a second single digital image of a magnification of the irradiated sample is acquired, step 214, with a depth of field at least corresponding to the thickness of the measurement cavity 20, FIG. 4b. No large gray dots are thus seen in FIG. 4b. The two acquired digital images are transferred to an image analyser for performing an electronic magnification image analysis, step 216, in order to compare the number of detected cells in the first digital image, FIG. 4a, with the number of detected cells in the second digital image, FIG. 4b. The detection of the magnetically labeled cells is thus performed by identifying cells that are not present in the second digital image compared to the first digital image.

Referring now to FIG. 5, a system for volumetric enumeration of magnetically labeled biological components in a liquid sample will be described. The system comprises a sample acquiring 502, device as defined above, and a measurement apparatus comprising a sample acquiring device holder 504, arranged to receive the sample acquiring device 502, containing a liquid sample in the measurement cavity, and means for applying a magnetic field to the measurement cavity, a light source 506 arranged to irradiate the liquid sample with electromagnetic radiation of a predetermined wavelength, an optical system 508, a diaphragm 510 directing the light to an imaging system comprising a digital image acquiring means 512 for acquiring at least one digital image of the irradiated sample in the measurement cavity. The magnetically labeled biological components are distinguished in the at least one digital image by selective electromagnetic wavelength imaging, and an image analyser arranged to analyse the acquired at least one digital image for identifying magnetically labeled biological components and determining the number of magnetically labeled biological components in the liquid sample. The magnetically labeled biological components are seen in the magnification 514 of the measurement cavity as gray dots, size enlarged compared to the other biological components for clarification, positioned at one wall of the measurement cavity.

Referring now to FIG. 6, an alternative system for volumetric enumeration of magnetically labeled biological components in a liquid sample will be described. The system comprises the same features as defined in FIG. 5, with the exception of the sample acquiring device holder 604. The sample acquiring device holder 604 is arranged to receive the sample acquiring device 502 and is arranged with means for applying a magnetic field to the measurement cavity from both sides of the measurement cavity and with means for moving the magnetic field along the measurement cavity, FIG. 6a, perpendicular to the irradiation direction. The magnetically labeled biological components are distinguished in the at least one digital image by selective electromagnetic wavelength imaging, and an image analyser arranged to analyse the acquired at least one digital image for identifying magnetically labeled biological components and determining the number of magnetically labeled biological components in the liquid sample. The magnetically labeled biological components are seen in the magnification 614a of the measurement cavity as gray dots, size enlarged compared to the other biological components for clarification, before applying the magnetic field. In FIG. 6b, the magnification 614b of the measurement cavity shows the biological components after application of the magnetic field and all large gray dots symbolizing the magnetically labeled biological components are positioned at one wall of the measurement cavity. In FIG. 6c, no large gray dots, symbolizing the magnetically labeled biological components, are seen in the magnification 614c of the measurement cavity after application of the magnetic field moving along the planar measurement cavity. All the magnetically labeled biological components have been moved away from the area wherefrom the image of the measurement cavity is acquired.

It should be emphasized that the preferred embodiments described herein are in no way limiting and that many alternative embodiments are possible within the scope of protection defined by the appended claims.

1-35. (canceled)

36. A method for detection of magnetically labeled biological components in a liquid sample, said method comprising
introducing a liquid sample into a measurement cavity of a sample acquiring device, said measurement cavity having a predetermined fixed thickness defined by two planar surfaces arranged at a predetermined distance from one another to determine a sample thickness and wherein said sample acquiring device comprises a reagent, the reagent comprising an antibody linked with a magnetic particle and being arranged in a dry form inside the measurement cavity,
mixing the reagent comprising an antibody linked with a magnetic particle with the liquid sample such that the antibody binds to a specific molecular structure of a biological component in the liquid sample,
irradiating the liquid sample by a light source with electromagnetic radiation of a predetermined wavelength,
acquiring a first at least one digital image of a magnification of the irradiated sample in the measurement cavity,
applying a magnetic field to the liquid sample in the measurement cavity, wherein the magnetic field is moved perpendicular to the irradiation direction of the sample acquiring device along the measurement cavity,
wherein the magnetic particle moves in the magnetic field, thereby moving the biological component to which the magnetically labeled antibody is bound to,
irradiating the liquid sample by a light source with electromagnetic radiation of a predetermined wavelength,
acquiring a second at least one digital image of a magnification of the irradiated sample in the measurement cavity after the magnetic field has been removed from said measurement cavity,
digitally analysing said first at least one digital image and said second at least one digital image for identifying biological components that are imaged in focus and determining types and number of these biological components, the types being distinguished by physical features of the components, and
identifying cells that are not present in the second acquired at least one digital image, said identifying comprising comparing said first at least one acquired digital image and said second at least one acquired digital image.

37. The method according to claim 36, wherein biological components exhibiting the specific molecular structure for the antibody to bind to are distinguished in the digital images as dark dots.

38. The method according to claim 36, wherein the digital image is acquired using an optical magnification power of 3-50×, more preferably 3-10×.

39. The method according to claim 36, wherein said analysing comprises identifying dark dots in the digital image in order to determine the number of magnetically labeled biological components.

40. The method according to claim 39, wherein said analysing comprises electronically magnifying the acquired digital image.

41. The method according to claim 36, wherein the liquid sample is introduced into the measurement cavity of the sample acquiring device through a capillary sample inlet by means of capillary force.

42. The method according to claim 36, wherein said first and said second digital image is a plurality of digital images using different optical settings.

43. The method according to claim 36, wherein said digital image is acquired with a depth of field at least corresponding to the thickness of the measurement cavity.

44. The method according to claim 36, wherein a volume of the analysed liquid sample is well-defined by the thickness of the measurement cavity and an area of the sample being imaged.

45. The method according to claim 36, wherein said irradiating is performed by a light source comprising a light emitting diode.

46. A system for volumetric enumeration of magnetically labeled biological components in a liquid sample, said system comprising:
a sample acquiring device comprising:
a measurement cavity for receiving a liquid sample, said measurement cavity having a predetermined fixed thickness, and
a reagent, which is arranged in a dry form inside the measurement cavity, said reagent comprising an antibody linked with a magnetic particle, wherein the antibody is arranged to bind to a specific molecular structure of a biological component and wherein the antibody linked with a magnetic particle and the biological component can be moved by applying a magnetic field to the measurement cavity, and
a measurement apparatus comprising:
a sample acquiring device holder, arranged to receive the sample acquiring device which holds a liquid sample in the measurement cavity, wherein the sample acquiring device holder comprises means for applying a movable magnetic field to the measurement cavity,
a light source arranged to irradiate the liquid sample with electromagnetic radiation of a predetermined wavelength,
an optical system,
a diaphragm arranged to direct the light,
an imaging system, comprising a digital image acquiring means for acquiring at least one digital image of a magnification of the irradiated liquid sample in the measurement cavity before and after applying the magnetic field, wherein the magnetically labeled biological components are distinguished in the digital image by selective electromagnetic wavelength imaging, and
an image analyser arranged to analyse the at least one acquired digital image for identifying magnetically labeled biological components that have changed their positions by the magnetic field and determining the number of magnetically labeled biological components in the liquid sample.

47. The system according to claim 46, wherein the imaging system is arranged to acquire a plurality of digital images of the liquid sample using different optical settings.

48. The system according to claim 46, wherein the imaging system is arranged with a depth of field of at least the thickness of the measurement cavity of the sample acquiring device.

49. The system according to claim 46, wherein a volume of an analysed sample is well-defined by the thickness of the measurement cavity and an area of the sample being imaged.

50. The system according to claim 46, wherein the light source is arranged to irradiate light of a wavelength corresponding to a peak in absorbance of the staining agent.

51. The system according to claim 46, wherein the light source comprises a light emitting diode.

52. The system according to claim 46, wherein the magnifying system has a magnification power of 3-50×, more preferably 3-10×.

53. The system according to claim 46, wherein the image analyser is arranged to identify dark dots in the digital image.

54. The system according to claim 46, wherein the image analyser is arranged to electronically magnify the acquired digital image.
